(19) United States
(12) Patent Application Publication
(10) Pub. No.: US 2002/0065054 A1
(43) Pub. Date: May 30, 2002

(54) Mobile station and elastomeric cover

(76) Inventors: Morris Humphreys, Saginaw, TX (US); Peter Lopez, Frisco, TX (US)

Correspondence Address: ROBERT C. ROLNIK, NOKIA INC., 6000 CONNECTION DRIVE, MD 1-4-755, IRVING, TX, 75039, US

(21) Appl. No.: 09/726,070

(22) Filed: Nov. 29, 2000

(51) Int. Cl. H04B 1/38

(52) U.S. Cl. 455/90; 455/575

(57) ABSTRACT

A elastomeric cover (300) is disclosed having a perimeter grip (321) for fitting on a raised lens of a mobile station. The elastomeric cover may have at least one strap (351), which may encircle parts of the mobile station. Button key-tops may be covered by the elastomeric cover, wherein the elastomeric cover may flex sufficiently so that the key-top may actuate a circuit. The elastomeric cover may block fluid ingress into the mobile station. The elastomeric cover may be removable without the use of tools.

### FIELD OF THE INVENTION

The invention relates to a keypad, and more particularly to a keypad that provides structural integrity to a mobile station, as well as provide enclosure walls that resist moisture ingress.

### BACKGROUND OF THE INVENTION

Use of mobile stations, including mobile phones by the public has grown to increased levels. The mobile phone is used in an increasing variety of circumstances and settings. The quantity of monthly minutes per user is increasing, particularly amongst experienced mobile phone owners. Attendant with such heavy use, is a growing frequency of dropping a mobile phone or exposing the mobile phone to liquids and other harmful environments.

Conventional mobile phones may be susceptible to liquid ingress into the phone wherever an opening appears in a mobile phone enclosure. The fewer openings that exist in the exterior of a mobile station, the better will be the resistance to liquid ingress.

Costs of building a mobile station tend to have a positive correlation to the number of discreet parts that need to be assembled. Where it is possible to form multiple parts out of a common material, costs can be reduced significantly. This is why it is often the case that mobile phone keypads are formed out of a single piece of rubber or elastomer.

There has been a growing trend to make mobile stations amenable to customization to suit the tastes of the owner of the mobile station. This is can be seen, for example, in the common use of interchangeable rigid faceplates to the Nokia® 5100 series mobile phones. Designs of figures and patterns on such covers, however, must work around the button grid located at the bottom front of the phone cover, i.e. the generally monochromatic buttons tend to distract from such cover art.

### SUMMARY OF THE INVENTION

One or more embodiments of the invention may provide a partly translucent flexible cover to a mobile station. Such a cover provides a circuit-board-enclosing shell, while providing the upper surface part of electromechanical buttons used to operate the mobile station. Such an arrangement provides fewer openings for water ingress as compared to many prior art, rubber-keypad-hard-cover combinations. Such an embodiment provides for elastomeric tension that wraps to a backside of a mobile station to keep the cover both attached and properly oriented in relation to the mobile station.

An embodiment may also provide an intermediate layer to a mobile station, wherein the intermediate layer is a monolithic part having movable key-tops and a shatter-resistant lens for, among other things, protecting a display of a mobile station. Such an embodiment supports the key-tops on extensions of semi-flexible material formed as one monolithic part.

The embodiment minimizes part count, doing many of the functions of a lens, gasket, cover and keypad of mobile station covers and supports of the prior art. The intermediate layer may operate connected to a mobile station without additional embodiments, or the intermediate layer may operate connected to a mobile station with a translucent flexible cover embodiment.

The foregoing embodiments, or parts thereof, when combined (particularly with a dome switch) make new embodiments by providing an electro-mechanical, actuating means or button structure with a superficial moisture barrier.

According to an embodiment of the invention, a flexible or elastomeric cover for a mobile station having a lens and buttons is disclosed. The embodiment has a translucent portion, at least one opposing surface and a perimeter grip having substantially the same perimeter as the lens.

According to another embodiment of the invention, a semi-rigid, front cover for a mobile station having a display and at least one key-dome switch is disclosed. The cover has a lens for protecting the display. The cover embodiment has at least one lever arm with a key-top mounted thereon. The key-top is situated to engage the key-dome switch to provide a switch-actuating means. The cover has a fastening means for attaching the cover to the mobile station.

According to still another embodiment of the invention, a button configuration for a mobile station is disclosed. The button configuration includes a key-dome switch and a key-top supported over the switch. An elastomeric sheet is placed over the key-top, which may provide some resistance to water ingress around the edges of the key-top.

At least one embodiment unifies the lens and elements of at least one button or key-top into a single piece. This simplifies manufacture of the mobile station, and keeps inventory in the manufacturing process to a smaller level. There is a potential to minimize assembly steps and improve reliability in final assembly.

An embodiment may provide a nearly planar surface that covers virtually all portions of a mobile station except a display. Such an arrangement may be more amenable to artistic expression, without compromising a need to denote button functionality with symbols printed thereon.

A mobile station equipped with an embodiment may be somewhat more resistant to sudden shocks because of the shock absorbing nature of elastomers.

Water may be more effectively repelled by an embodiment to the extent that openings around buttons no longer exist at the most outer layer of the mobile station when the embodiment is mated to the mobile station. In addition, some areas of what may be called a circumferential junction between front cover and back cover may be additionally shielded by an elastomeric embodiment of the invention.

### BRIEF DESCRIPTION OF THE DRAWINGS

The disclosed inventions will be described with reference to the accompanying drawings, which show sample embodiments of the invention, wherein:

FIG. 1 shows an exploded view of an embodiment of the invention with a mobile station;

FIG. 2a shows a detailed view of a front cover embodiment of the invention;

FIG. 2b shows a side view of the front cover embodiment of the invention;

FIG. 3 shows an elastomeric cover embodiment of the invention;

FIG. 4 shows a close-up view of the elastomeric cover embodiment of the invention;

FIG. 5a shows a cross-sectional view of a button of an embodiment of the invention;

FIG. 5b shows a cross-sectional view of a button according to another embodiment; and

FIG. 5c shows a cross-sectional view of a button according to yet another embodiment.

### DETAILED DESCRIPTION OF THE PREFERRED EMBODIMENTS

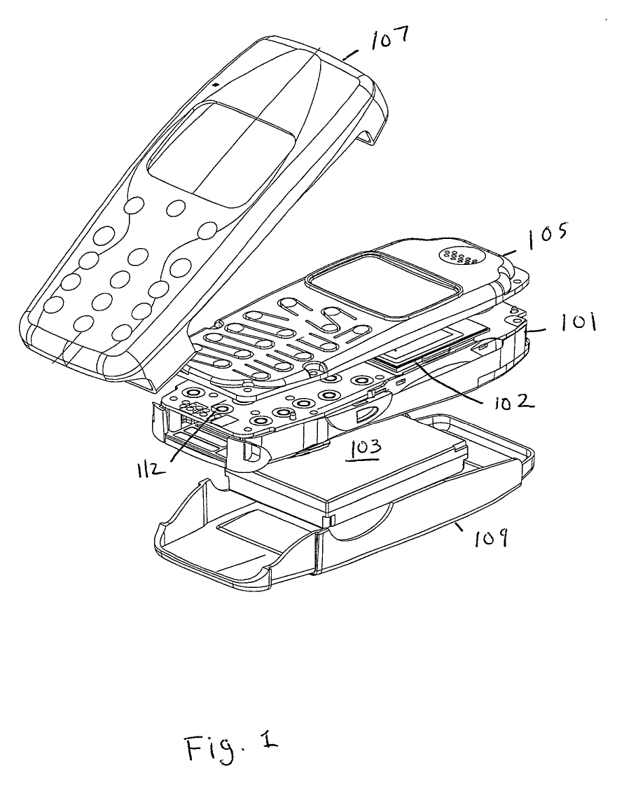

FIG. 1 shows an exploded view of one or more embodiments of the invention. FIG. 1 shows an embodiment of the invention, which provides a front cover 105 with integral button key-tops and lens. To aid in back-lighting of button surfaces, the cover 105 may be translucent in parts. Because components on an upper-circuit board may be fragile or susceptible to short circuiting, it is a common practice to enclose the upper-circuit board with a cover.

The cover alone may be insufficient to shelter and hold the battery 103. Thus the addition of an elastomeric cover 107 and a back cover 109 may provide shelter, among other things. A back cover 109 may provide the completing piece to a predominantly rigid mobile station. The mobile station chassis may have key-dome switches placed on a printed circuit board. Other switches may be used as an alternative; however, any portion of the switch that closes a circuit because of a moved position may be a type of button portion 112. Additional layers above the button portion may modify such a mobile station chassis 101. Such additional layers may be embodiments and may provide additional surfaces and platforms that enhance tactile feedback of buttons, reduce forces needed to actuate buttons, or otherwise provide protection to buttons against insertion of foreign objects or water amongst button elements. One or more of such surfaces and platforms may be button portions.

The chief component that the foregoing front cover 105 may mate or fasten to is a mobile station comprised of a number of circuits that support, among other things, an antenna, a transceiver, sound input and output devices, and push-button sensors. A display 102 is provided so that feedback is available when entering phone numbers and other data to the mobile station. The chief supporting structure may be one or more printed circuit boards bonded or otherwise fastened together. Such an aggregation of circuit boards may be a mobile station chassis 101, which may include one or more stiffening members. The construction of a mobile station may be modular, and may permit a battery 103 to be attached by two or more leads. Thus the front cover 105 may offer protection, and possibly additional rigidity to the mobile station chassis. The assembly of the front cover 105 to mobile station chassis 101 may be called a modified mobile station.

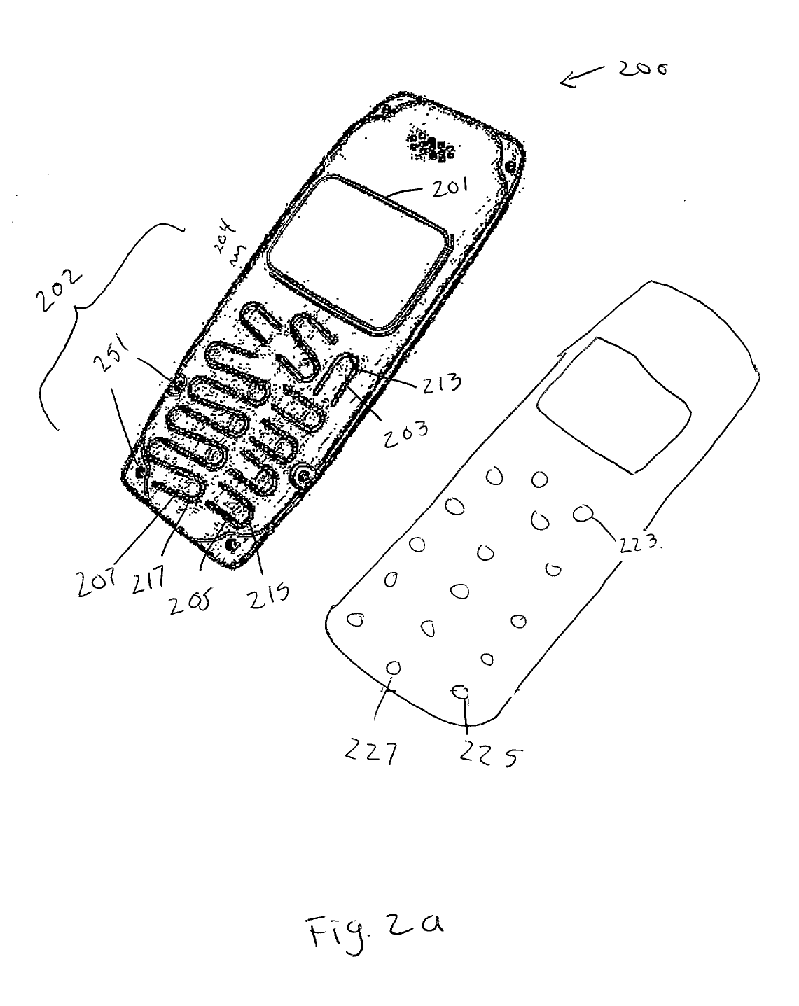

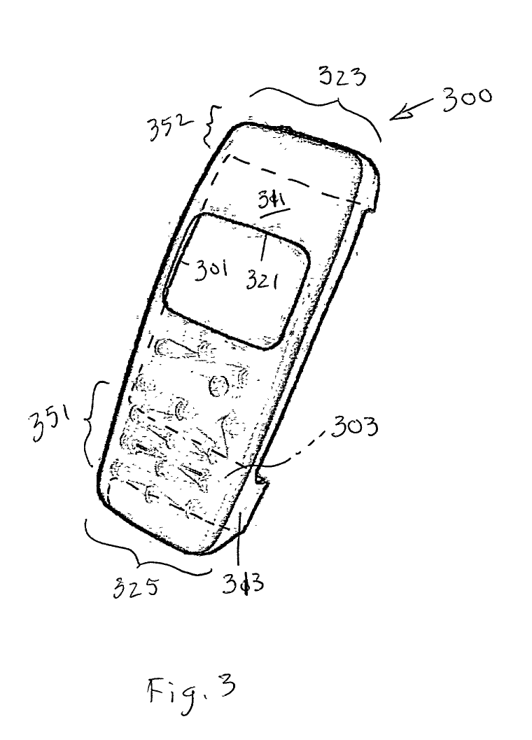

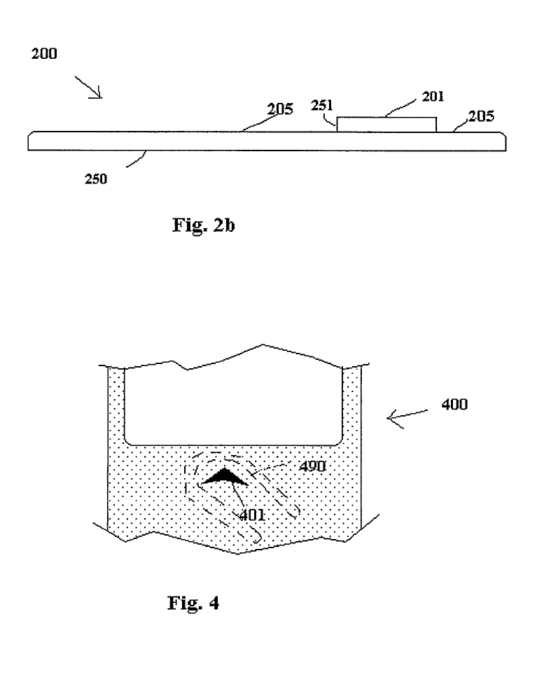

FIG. 2 shows a detailed view of a front cover 200 according to an embodiment. A lens 201 is snugly fitted superimposed over the display, wherein the lens has lateral dimensions similar to the display. The front cover may be made of a material selected to be stiff, yet sufficiently flexible for button-levers or lever arms that may be deflected by ordinary finger strength of a person. At least one button portion is located in a button zone 202 that is disposed in a second half of the front cover. A small area having a generally flat surface 204 may connect the button portion 202 to the lens 201. Lever arms 203, 205, and 207 may provide a support for key-tops 213, 215 and 217 whereby the key-tops may be positioned above key-domes 223, 225, and 227 on a mobile station chassis or circuit board. The key-domes may be made of polyester, Mylar™, or other materials as is known in the art. The positioning of the key-domes and lens in relation to the chassis may be accomplished by screw-holes 251, snap fittings or other fastener means known in the art.

The front cover 200 may be tinted, painted, finished to be transparent, opaque or translucent; however, if backlit key symbols are desired, some areas close to the symbols may be made transparent to light. The lens 201 may have dimensions of length and width, which collectively establish a perimeter. The perimeter may be rectangular. FIG. 2b shows how a lens may be elevated from a surrounding surface 205 of the front cover. The cover has a side 250 that faces the mobile chassis. The lens 201 may be elevated from the surrounding surface 205 of the front cover wherein the upper surface of the lens forms a plateau above the surrounding surface, said plateau having walls 251 that may rise vertically from the surrounding surface. The walls need not be parallel; however, the walls may operate best if the walls form acute angles with the surrounding surface, i.e. an elastomeric cover may fit better around the walls in that situation.

FIG. 3 shows a detailed view of an elastomeric cover 300 embodiment of the invention, sometimes called a flexible cover. The elastomeric cover has first inner surface 301 and second inner surface 303 that partially enclose a volume, and so can be said to have inner surfaces and outer surfaces 311 and 313. Because the elastomeric cover 300 must be resistant to accidental slippage or removal from the assembled mobile station, it is constructed with a first inner surface 301 and a second inner surface 303 which may have surface normals pointed in substantially opposite directions. FIG. 3 shows a first strap 351, which may encircle a front cover. In addition there is a second strap 352 or top strap which may also encircle a front cover. The second strap 352 may still be called a strap, even if there is an absence of any gap or hole at the top of the elastomeric cover.

A rim is a specific form of a strap. A rim is sized to encircle a single monolithic part and may keep a surrounding elastomeric material strongly biased to a position snug against the single part.

Though the elastomeric cover may be flexible, it has a slight bias toward a shape that encloses a volume having dimensions of height, width and length that may be slightly smaller than the height, width and length of the combined front cover, mobile station chassis, and back cover assembly. Sliding the elastomeric cover 300 around such an assembly may provide a bias that holds the back cover in place against the combined chassis and front cover, thus holding the assembly together in a manner similar to the use of a rubber band.

Protruding parts of the mobile station and front cover may provide an orienting function in relation to the elastomeric cover. For example, the lens may extend from the front cover with substantially parallel supporting walls. A perimeter grip 321 or hole in the elastomeric cover may have dimensions substantially the same as, or smaller than the lateral dimensions of the lens. Placing the elastomeric cover around the lens may stabilize the elastomeric cover from shifting as the mobile station is handled and stored. Moreover, a tight seal may be accomplished. Note that the lens may have an irregular shape in that it need not be rectangular. The perimeter grip 321 is a type of rim.

A broad side of a strap may provide a surface that is contiguous with a surrounding surface of a rim. A surface is contiguous if it has a flat, or gently bending contour. FIG. 3 shows a broad side of strap 351 that is contiguous with the surrounding surface of the perimeter grip.

The lens may be made of a plastic or other material that is not brittle. Though the lens may provide the chief protection for any Liquid Crystal Display (LCD) of the mobile station, an embodiment may provide additional protection by providing no opening sized to fit around the lens. In other words, an embodiment may be sufficiently transparent that the embodiment may cover the lens without substantially degrading the visibility of the LCD. This embodiment may enhance water resistance perhaps at the expense of unblemished visibility of the LCD. If such an elastomeric cover is subject to degradation due to wear and tear, manufacturing costs may be sufficiently low to make the elastomeric cover disposable in a rapid replacement cycle.

FIG. 4 shows a close-up view of a surface of an elastomeric cover 400. The surface may carry a mark 401 that may be transparent to light. Such a mark 401 may serve either functional or aesthetic purposes, i.e. the mark 401 may indicate a function that occurs when a button is depressed, or the mark 401 may provide a consistent color to the overall pattern of the cover, so that artwork is perceived as a whole on the cover. Functional marks may be placed near surfaces that are supported by a key-top 490. The mark may be a translucent portion. On the other hand, good contrast to show a symbol may occur by inverting the light and dark sections such that the part or parts of the cover that are not the one or several marks is a translucent portion, while the marks may be opaque, or nearly so. Alternatively, any translucent arrangement that permits the entire cover to be translucent, but provides contrast between marks and surrounding areas, may satisfy the goal of permitting back-lighting of the marks.

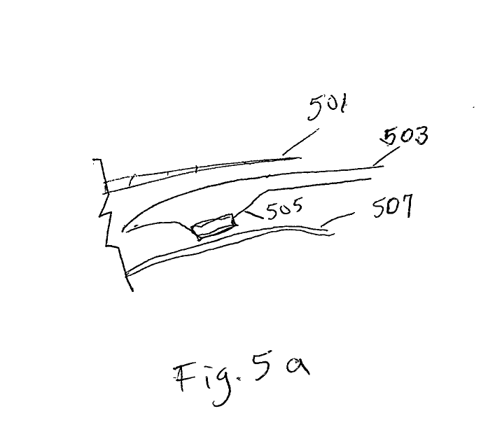

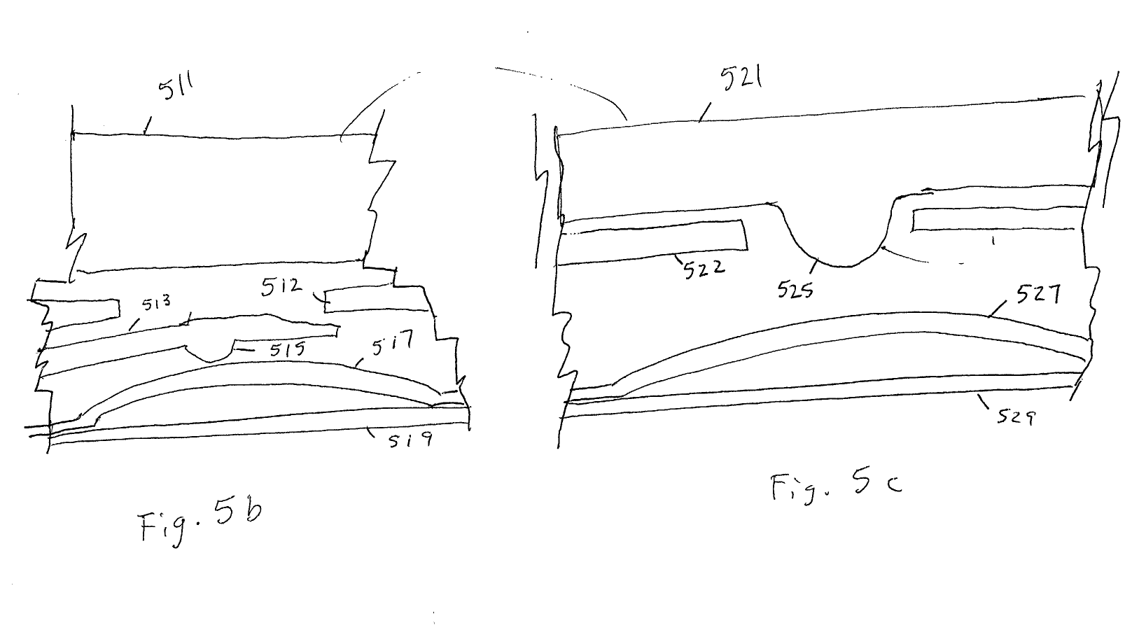

FIG. 5a shows a cross-sectional view of a button according to an embodiment. A button may have indistinct outer edges, i.e. the button surface may blend with the surrounding flexible cover. The upper layer is an elastomeric cover 501, which may be a sheet held in place by a combination of elastic tension and friction. Beneath the elastomeric cover is a key-top 503, which may be part of a front cover. Key-top 503 may have a bias upward, toward the elastomeric cover 501. Key-top may have a convex lower surface 505 that is suitable for collapsing a dome for a dome switch. Other switches may be actuated by lower surface 505 as is known in the art. A key-dome switch 507 may be disposed below the convex lower surface 505. A printed wiring board 509 may provide an open circuit that may be closed when in contact with the key-dome switch 507.

FIG. 5b shows a cross-sectional view of a button according to another embodiment. The upper layer is an elastomeric cover 511, which may be a sheet held in place by an elastic tension. Beneath the elastomeric cover 511 is a cover support 512, which may provide a gap or hole that permits some vertical travel for the cover prior to touching any third object. A post 515 may be positioned near the hole by a finger 513, which may extend between buttons. A key-dome switch 517 may be disposed below the post 515. A printed wiring board 519 may provide an open circuit that may be closed when in contact with the key-dome switch 517.

FIG. 5c shows a cross-sectional view of a button according to yet another embodiment. The upper layer is an elastomeric cover 521. Beneath the elastomeric cover is a cover support 522, which may provide a gap or hole that permits some vertical travel for the cover prior to touching any third object. A post 525 may extend partially into the hole. A key-dome switch 527 may be disposed below the post 525. A printed wiring board 529 may provide an open circuit that may be closed when in contact with the key-dome switch 527. Elastomeric cover 521 may have a tactile cue for each button, which may include a dimple, a ridge, or a elevated bump to provide tactile feedback to fingers searching for button centers. Such a tactile cue may be located above key-dome switch centers.

In each of the foregoing embodiments, the deformable, outer surface of a button presents visually indistinct boundaries with the rest of the elastomeric cover. Prior art buttons has elastomer extending through relatively rigid holes. This was generally accomplished by making the elastomeric tops of the prior art buttons with sharp transitions from button top to button support or wall.

Parts of the mobile station may be shielded from some shocks by embodiments of the invention. Such embodiments include the provision of elevated thickness to the elastomeric cover. Such a thickness would be the distance between an inner surface and an outer surface of the elastomeric cover. The increased thickness may be called a bumper. Bumpers may be located at the extremities of the cover, e.g. where the cover meets a rounded corner of the mobile station chassis. FIG. 3 shows a top extremity 323 and a bottom extremity 325. Bumpers may be provided at extremity 323 and extremity 325. Furthermore, one or more bumpers may be located near the perimeter grip such that the elastomeric material of the elastomeric cover extends above any supporting walls of the lens. This may have the effect of reducing scratching upon the occasional drop of the mobile station.

Although the invention has been described in the context of particular embodiments, various alternative embodiments are possible. For example, switches other than key-dome switches may be used. Thus, while the invention has been particularly shown and described with respect to specific embodiments thereof, it will be understood by those skilled in the art that changes in form and configuration may be made therein without departing from the scope and spirit of the invention.

What is claimed is:

1. A flexible cover for a mobile station having a lens portion, said lens portion having a lens perimeter, and wherein said mobile station has at least one button portion comprising:
a front surface having a translucent portion, said translucent portion being capable of mounting over at least one button portion;
at least one strap; and
at least one rim wherein the rim may be stretched to hold the lens portion.

2. The flexible cover of claim 1 wherein the rim is a perimeter grip.

3. The flexible cover of claim 2 wherein the perimeter grip has a perimeter substantially the same as the lens perimeter.

4. The flexible cover of claim 1 wherein the at least one strap comprises two straps.

5. The flexible cover of claim 1 wherein the at least one strap has a strap broad side that is contiguous with a surrounding surface of the at least one rim.

6. The flexible cover of claim 1 further comprising:
at least one bumper at an at least one extremity.

7. The flexible cover of claim 1 further comprising:
at least one bumper near the at least one rim.

8. The flexible cover of claim 1 wherein the translucent portion has at least one symbol.

9. A semi-rigid cover for a mobile station having a display and at least one key-dome switch comprising:
a transparent lens supported over the display;
at least one lever arm supporting at least one key-top over said at least one key-dome;
at least one fastening means.

10. The semi-rigid cover of claim 9 wherein the transparent lens is elevated from a surrounding surface.

11. The semi-rigid cover of claim 10 wherein the transparent lens has at least one wall having an acute angle with the surrounding surface.

12. A button configuration for a mobile station comprising:
a key-dome switch;
a key-top supported over the key-dome switch;
a substantially flat elastomeric sheet extending over the key-top.

13. The button configuration of claim 12 wherein the key-top is supported by a lever arm.

14. The button configuration of claim 12 wherein the key-top is supported by a clear lever arm.

15. The button configuration of claim 14 wherein the clear lever arm is formed from a common material with a lens.

16. The button configuration of claim 15 wherein the common material has a means for fastening to a printed circuit board.

17. The button configuration of claim 12 wherein the substantially flat elastomeric sheet has a tactile cue.

18. The button configuration of claim 16 wherein the tactile cue is supported over the key-dome switch by tension.

19. The button configuration of claim 12 wherein the substantially flat elastomeric sheet has a symbol.
